(19) United States
(12) Patent Application Publication
(10) Pub. No.: US 2007/0145757 A1
(43) Pub. Date: Jun. 28, 2007

(54) Tool

(75) Inventor: Chang-Yao Wu, Taipei City (TW)

Correspondence Address: BACON & THOMAS, PLLC, 625 SLATERS LANE, FOURTH FLOOR, ALEXANDRIA, VA, 22314, US

(73) Assignee: Test Rite International Company, LTD., Taipei City (TW)

(21) Appl. No.: 11/357,077

(22) Filed: Feb. 21, 2006

(30) Foreign Application Priority Data
Dec. 22, 2005 (CN) 200510132186.7

(51) Int. Cl. A01B 1/22

(52) U.S. Cl. 294/58; 294/53.5; 294/60

(57) ABSTRACT

A tool is provided, comprising: a main handle; a first grip, fixedly locked on one end of the main handle; a connecting stick, fixedly locked on the other end of the main handle; an auxiliary handle, one end thereof is pivotably provided on a second grip, and the other end thereof is pivotably connected to the connecting stick; and a shovel bowl, having a connecting part, shoulders, and a shovel pan, the connecting part of the shovel bowl is fixedly locked on the connecting stick, the auxiliary handle is attached in the longitudinal direction of the main handle and can be rotationally swung with respect to the main handle.

### BACKGROUND OF THE INVENTION

1. Field of the Invention

The present invention relates to a tool, and more particularly to a tool that can save effort and easily clean away shoveled things.

2. Description of the Related Art

As shown in FIG. 17, a three-dimensional view of a conventional shovel is shown. The conventional shovel comprises a main handle 61, and a grip 62 and a shovel bowl 63 are respectively provided on two ends thereof. A user can hold the grip 62 by one hand and hold the main handle 61 with the other hand to operate the shovel. When the user uses the shovel bowl 63 to shovel some things and intends to clean away the shoveled things, the user needs to rotate his two arms in order to overturn the shovel bowl 63 and then clean away the shoveled things.

The above conventional shovel is not convenient for use, because in operating the conventional shovel the user must bend down and apply a force with two hands in order to shovel things. Moreover, when the shoveled things are heavier, it would be very effort consuming to clean away the shoveled things, or even the user will carelessly sprain his arm or fracture his vertebra bone. Consequently, it is not possible for some users who are powerless, handicapped, or even old to operate the conventional shovel. Therefore, the conventional shovel still has drawbacks and further improvements are desirable.

### SUMMARY OF THE INVENTION

It is one object of the present invention to provide a tool provided with a main handle and an auxiliary handle being respectively held and operated by two hands of a user. Further, the auxiliary handle can be rotationally swung with respect to the main handle, such that it can easily clean away shoveled things.

It is another object of the present invention to provide a tool, in which the shovel bowl of the tool is provided with a sprocket such that the shovel bowl can have different angles for the convenience of a user to shovel things.

It is still another object of the present invention to provide a tool, in which the shovel bowl is provided with treading parts on which a user can apply the force by his leg. The treading parts have the slip-proof function.

For achieving the above purposes, the tool according to the present invention comprises: a main handle; a first grip, fixedly locked on one end of the main handle; a connecting stick, fixedly locked on the other end of the main handle; an auxiliary handle, one end thereof is pivotably provided on a second grip, and the other end thereof is pivotably connected to the connecting stick; and a shovel bowl, having a connecting part, shoulders, and a shovel pan, the connecting part of the shovel bowl is fixedly locked on the connecting stick, the auxiliary handle is attached in the longitudinal direction of the main handle and can be rotationally swung with respect to the main handle.

Preferably, a pull rod is further provided through the main handle, and a pull handle and an engaging part are respectively provided at either side thereof.

Preferably, a spring is further provided through the pull rod, and one end thereof stands up on the first grip.

Preferably, the shovel bowl is provided with a sprocket for engaging with the engaging part of the pull rod.

Preferably, the shovel bowl is further pivotably provided with treading parts.

Preferably, the shovel bowl is further provided with a fastening part and a spring, one end of the spring is connected to the fastening part, and the other end of the spring is connected to the treading part.

Preferably, the other end of the auxiliary handle is provided with a fastening ring for pivotably connecting the connecting stick.

Preferably, the auxiliary handle is provided with a tenon, and a hole is provided at a place of the main handle corresponding to the tenon of the auxiliary handle. The tenon can be positioned into the hole of the main handle.

The advantages of the present invention are as follows:
1. The main handle and the auxiliary handle are specially designed and can save effort, such that it is convenient for users who are powerless, handicapped, or even old to operate and use the tool.
2. The pull rod and the sprocket are specially designed such that the shovel bowl can have four different angles for the convenience of an operator to shovel things.
3. The movable treading parts are specially designed and have the slip-proof function, such that a slip-off due to the moist weather or the user does not put on suitable shoes can be avoided.

### BRIEF DESCRIPTION OF THE DRAWINGS

FIG. 1 is a three-dimensional view of a preferred embodiment of the tool according to the present invention.

FIG. 2 is a front view of a preferred embodiment of the tool according to the present invention.

FIG. 3A is an enlarged view of the circle D shown in FIG. 2, FIG. 3B illustrates the rotation of the second grip.

FIG. 4 is a cross-sectional view along the line A-A in FIG. 2.

FIG. 5A is an enlarged view of the circle E shown in FIG. 4, FIG. 5B illustrates the rotation of the second grip, FIG. 5C illustrates the separation of the auxiliary handle and the main handle.

FIG. 6A is an enlarged view of the circle F shown in FIG. 4, FIG. 6B illustrates that an angle β₁ is formed between the shovel pan and the main handle, FIG. 6C illustrates that an angle β₂ is formed between the shovel pan and the main handle, FIG. 6D illustrates that an angle β₃ is formed between the shovel pan and the main handle.

FIG. 7A is an enlarged view of the circle G shown in FIG. 4, FIG. 7B illustrates the stretching of the pull rod in utilizing conditions.

FIG. 8 is a three-dimensional view of another preferred embodiment of the tool according to the present invention.

FIG. 9 is a front view of another preferred embodiment of the tool according to the present invention.

FIG. 10 is a cross-sectional view along the line B-B in FIG. 9.

FIG. 11 is an enlarged view of the circle H shown in FIG. 10.

FIG. 12 illustrates different angles between the shovel pan and the main handle.

FIG. 13A is an enlarged view of the circle I shown in FIG. 10, FIG. 13B illustrates the stretching of the pull rod in utilizing conditions.

FIG. 14 is a rear view of a preferred embodiment of the shovel bowl.

FIG. 15 is a three-dimensional view of yet another preferred embodiment of the tool according to the present invention.

FIG. 16 is a three-dimensional view of still yet another preferred embodiment of the tool according to the present invention.

FIG. 17 is a three-dimensional view of a conventional shovel.

### DETAILED DESCRIPTION OF THE PREFERRED EMBODIMENTS

Although the present invention will be described in considerable detail with reference to certain preferred embodiments thereof, however prior to this description, it is should to be understood that those skilled in the art can easily make changes to the present invention described herein and the same performance as the present invention is obtained. Therefore, it is to be understood that the following description is a general disclosure to those skilled in the art and is not restrictive of the present invention.

Some examples of the present invention will be described by way of embodiments in relation to the appended drawings and are not restrictive of the scope of the present invention as claimed.

### EMBODIMENTS

### Embodiment I

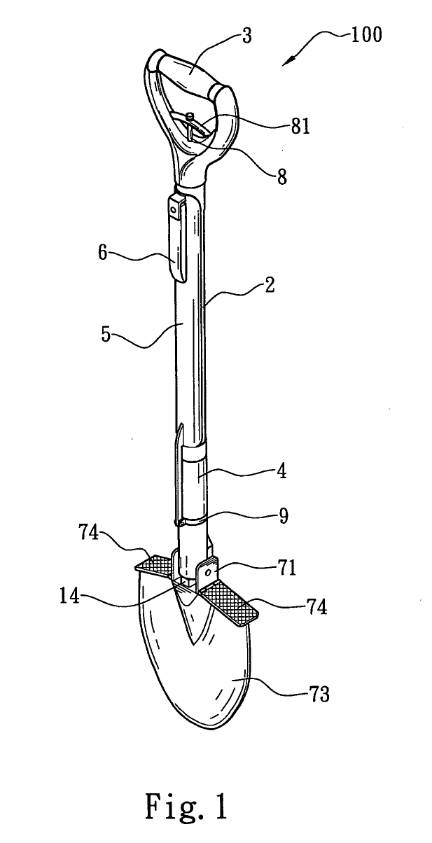

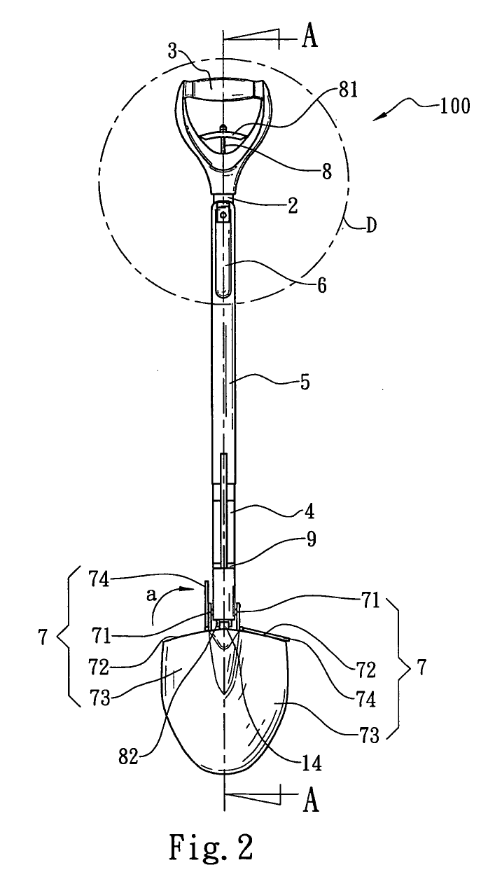

Referring to FIG. 1, a three-dimensional view of a preferred embodiment of the tool according to the present invention is shown. In the preferred embodiment of the present invention, the tool of the present invention is a shovel 100, comprising: a main handle 2; a first grip 3, fixedly locked on one end of the main handle 2; a connecting stick 4, fixedly locked on the other end of the main handle 2; an auxiliary handle 5, one end thereof is pivotably provided on a second grip 6, and the other end thereof is pivotably connected to the connecting stick 4; a shovel bowl 7 (see in relation to FIG. 2 for a front view of a preferred embodiment of the tool according to the present invention), having a connecting part 71, shoulders 72, and a shovel pan 73, the connecting part 71 of the shovel bowl 7 is fixedly locked on the connecting stick 4; and a pull rod 8, passing through the main handle 2, and a pull handle 81 and an engaging part 82 are respectively provided at either side thereof.

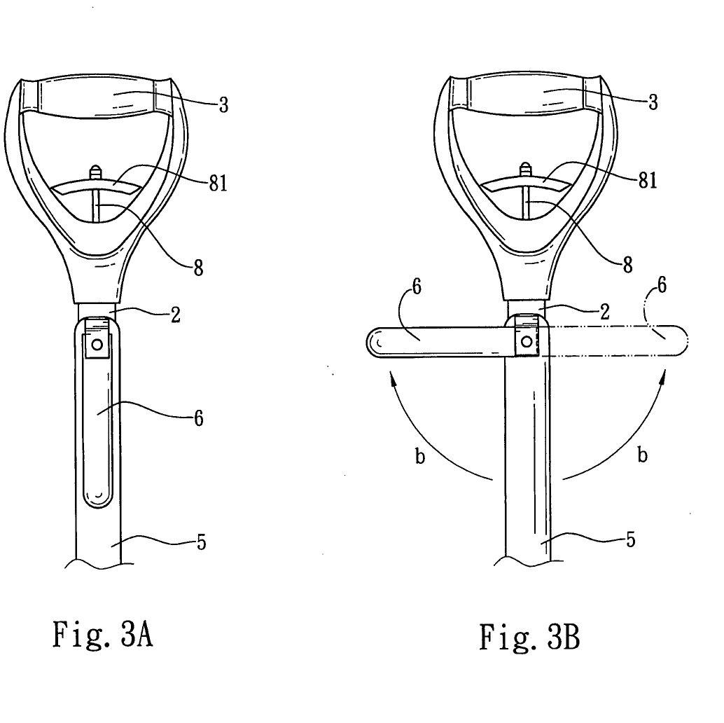

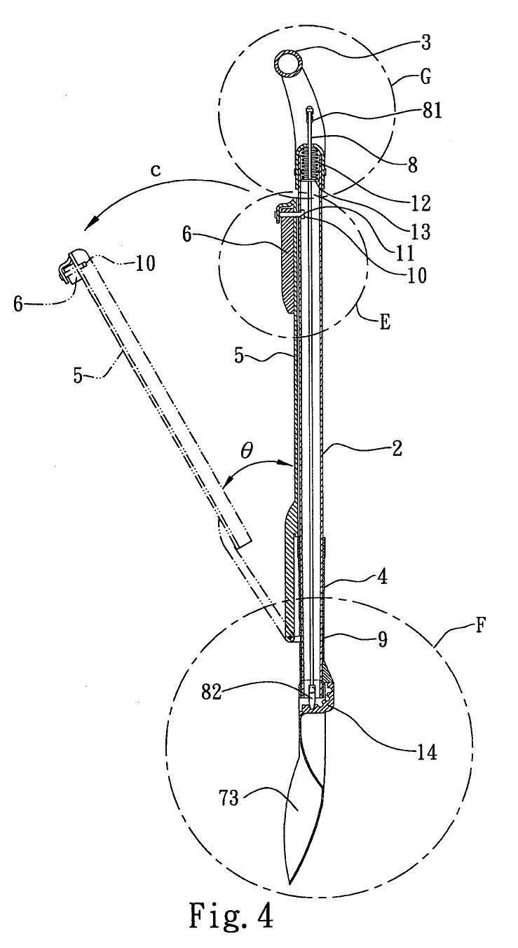

FIG. 3A, FIG. 3B, and FIG. 4 illustrate respectively an enlarged view of the circle D, the rotation of the second grip, and a cross-sectional view along the line A-A in FIG. 2, and can be viewed in relation to FIG. 1 and FIG. 2. The other end of the auxiliary handle 5 is provided with a fastening ring 9 for pivotably connecting the connecting stick 4, such that the auxiliary handle 5 can make a 360° rotational swing with respect to the main handle 2, and the auxiliary handle 5 is attached in the longitudinal direction of the main handle 2 via a tenon 10 positioned into a hole 11 of the main handle 2. When a user rotates the second grip 6 along the direction indicated by an arrow b in FIG. 3B (the second grip 6 can be rotated in two directions for the operative custom of different users) and then applies a force along the direction indicated by an arrow c in FIG. 4, an angle θ will be formed between the auxiliary handle 5 and the main handle 2.

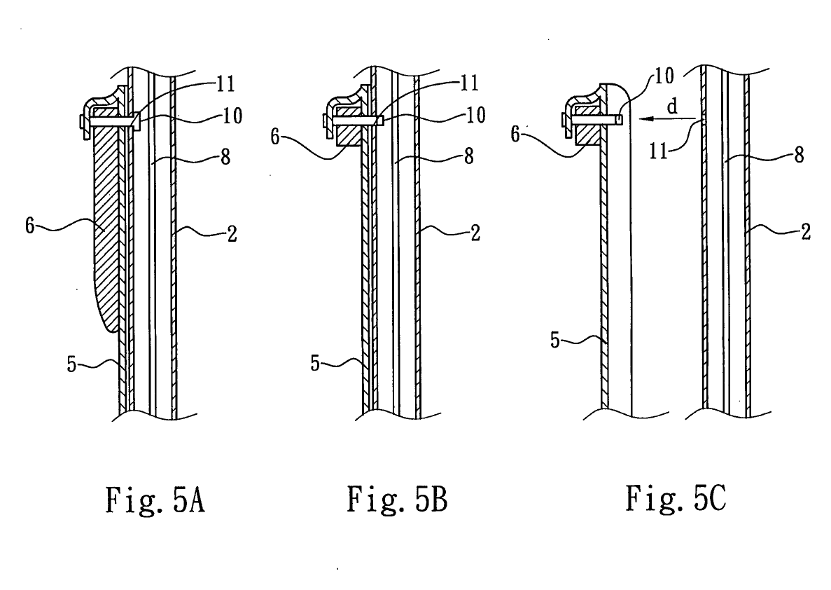

Referring to FIG. 5A, FIG. 5B and FIG. 5C, an enlarged view of the circle E shown in FIG. 4, the rotation of the second grip, and the separation of the auxiliary handle and the main handle are respectively shown. When a user rotates the second grip 6 and makes the tenon 10 turn around, the tenon 10 will move outward along the direction indicated by an arrow d, such that the auxiliary handle 5 can be separated from the main handle 2.

When the first grip 3 and the second grip 6 are respectively held by two hands of a user, because the auxiliary handle 5 can be rotationally swung with respect to the main handle 2, the user can therefore adjust the angle θ spread between the auxiliary handle 5 and the main handle 2 and the direction as he wishes, such that the user can operate the shovel 100 under the condition most suitable for applying the force.

Continuing referring to FIG. 2, the shovel bowl 7 further pivotably provides treading parts 74. The treading parts 74 can be magnetically attached to the shoulders 72 and approximately vertical to the main handle 2. The treading parts 74 can also be movably adjusted (along the direction indicated by an arrow a shown in FIG. 2) and magnetically attached to the connecting part 71 and parallel to the main handle 2. When the shovel 100 is operated, a user can adjust the treading parts 74 to make them magnetically attached to the shoulders 72 and approximately vertical to the main handle 2. The treading parts 74 have the slip-proof function, such that a slip-off due to the moist weather or the user does not put on suitable shoes can be avoided when the user steps on the treading part 74 and applies a force downward.

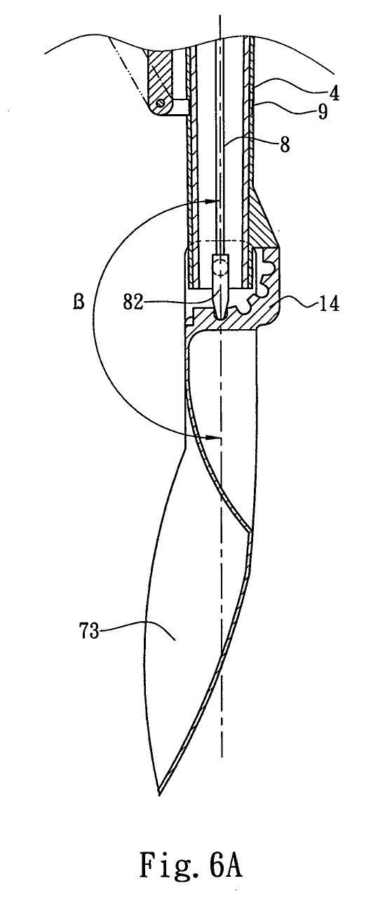

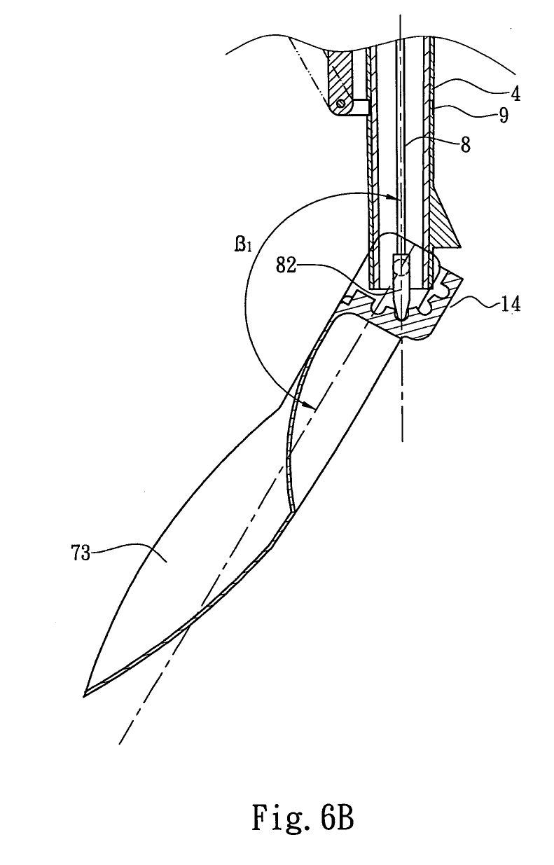

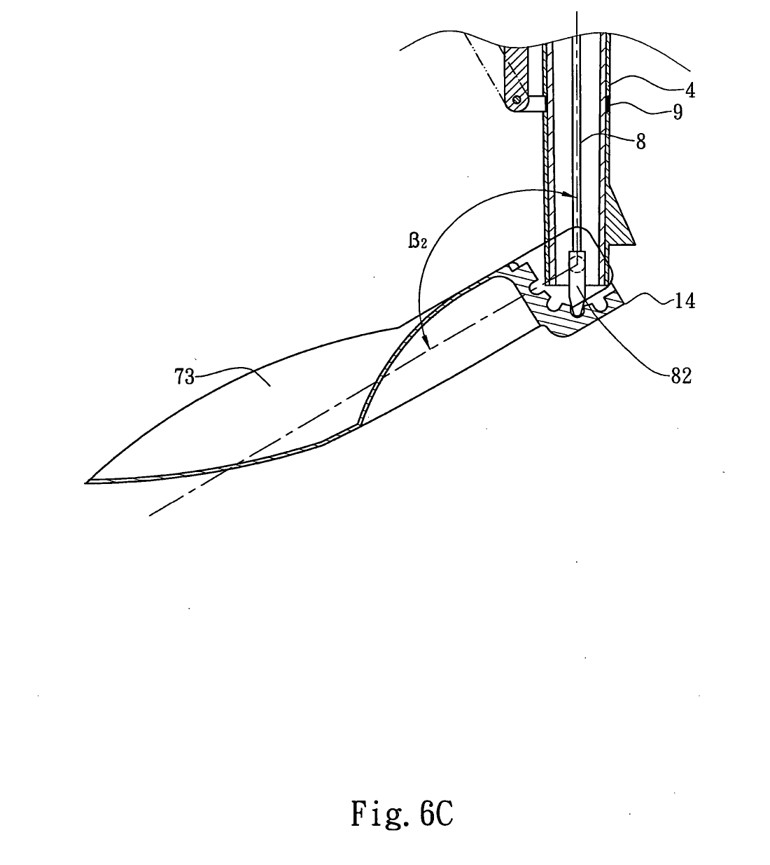

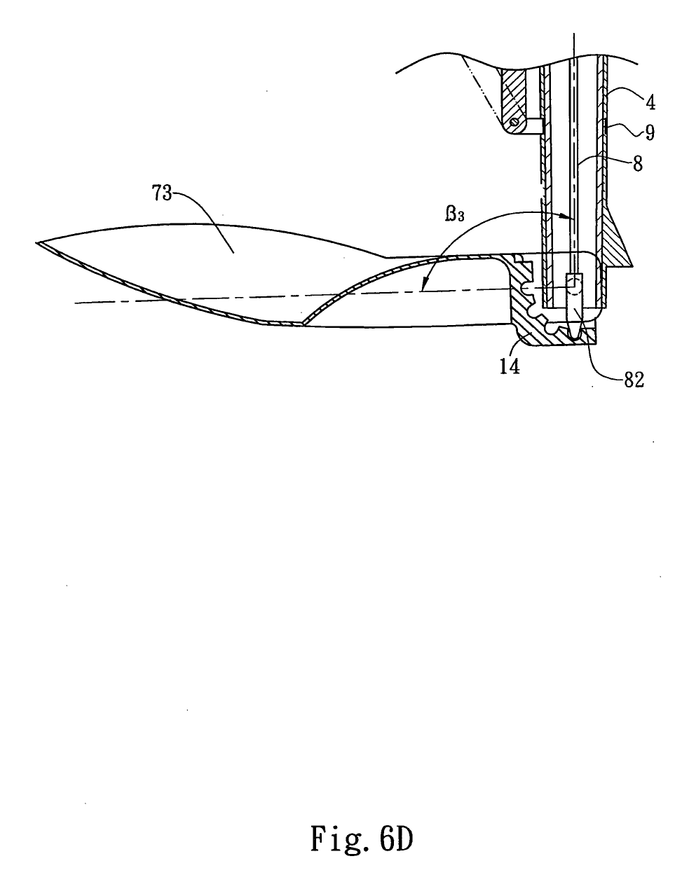

Referring to FIG. 4, a spring 12 passes through the pull rod 8. One end of the spring 12 stands up on the first grip 3, and the other end thereof stands up on a circle disk 13 provided on the pull rod 8. The shovel bowl 7 is further provided with a sprocket 14 for engaging with the engaging part 82 of the pull rod 8, such that different angles can exist between the shovel pan 73 of the shovel bowl 7 and the main handle 2. FIG. 4 can be referred in relation to FIG. 6A, FIG. 6B, FIG. 6C, and FIG. 6D for the enlarged view of the circle F shown in FIG. 4, that is different angles can exist between the shovel pan 73 and the main handle 2. In preferred embodiments of the invention, different angles such as β [symbol] β₁ [symbol] β₂ [symbol] and β₃ can exist between the shovel pan 73 and the main handle 2 for the convenience of a user to operate the shovel 100 to shovel various things.

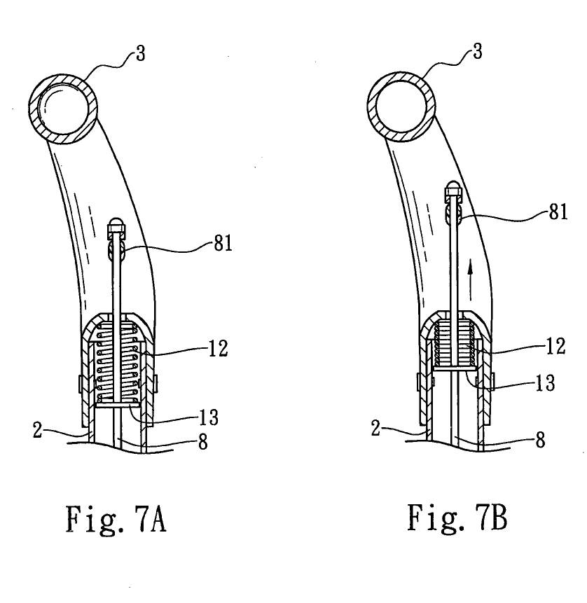

When an angle β exists between the shovel pan 73 and the main handle 2, the shovel 100 can be operated by the user to insert into the earth. When the user wants to shovel the earth, he can pull the pull handle 81 (referring to FIG. 7A and FIG. 7B for an enlarged view of the circle G shown in FIG. 4 and the stretching of the pull rod 8 in utilizing conditions) and then the spring 12 will be pressed and the engaging part 82 will departs from the recess of the sprocket 14, such that the shovel pan 73 can be rotationally swung with respect to the main handle 2, that is the user can appropriately adjust or select the angle (e.g. β₁ [symbol] β₂ [symbol] or β₃) between the shovel pan 73 and the main handle 2. When the user releases the pull handle 81 (the spring 12 will resiliently return to the original location), the engaging part 82 will be positioned in the recess of the sprocket 14 in order to fix the shovel pan 73. Meanwhile, the user can shovel the earth by applying a force on the first grip 3 of the shovel 100 (using the second grip 6 as a fulcrum) or on the second grip 6 (using the first grip 3 as a fulcrum), and then the user can turn over the shovel pan 7 by rotating the arm holding the first grip 3, thereby the earth in the shovel pan 73 can be cleaned away. This is a convenient and effort-saving process.

After use, the user can first rotate the auxiliary handle 5 and then position the auxiliary handle 5 into the hole 11 of the main handle 2 via the tenon 10 of the auxiliary handle 5, such that the auxiliary handle 5 can be attached in the longitudinal direction of the main handle 2 for reducing the space occupied by the shovel 100 and for the convenience of store-up for the user.

### Embodiment II

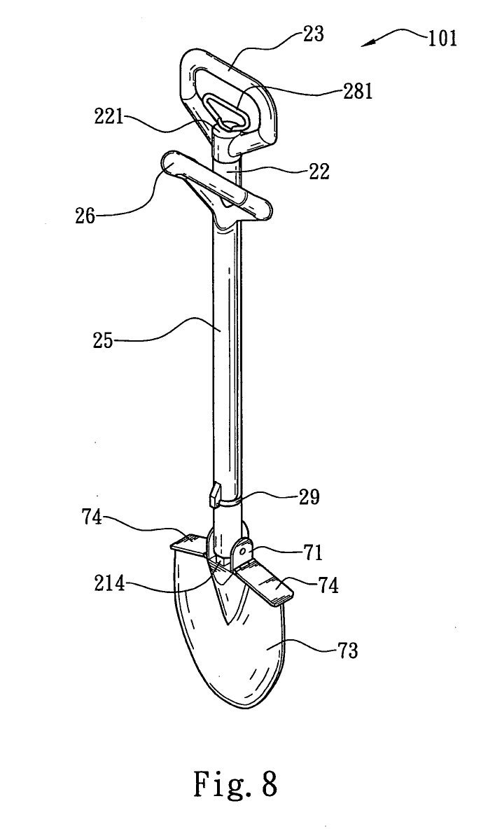

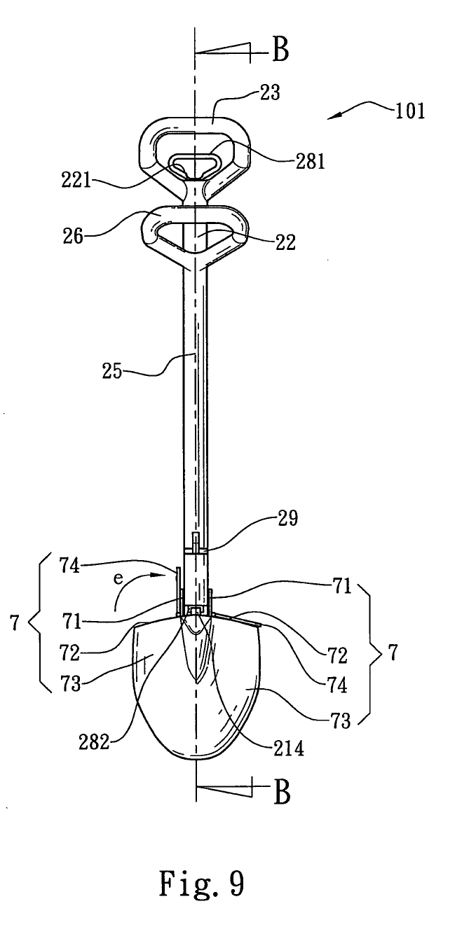

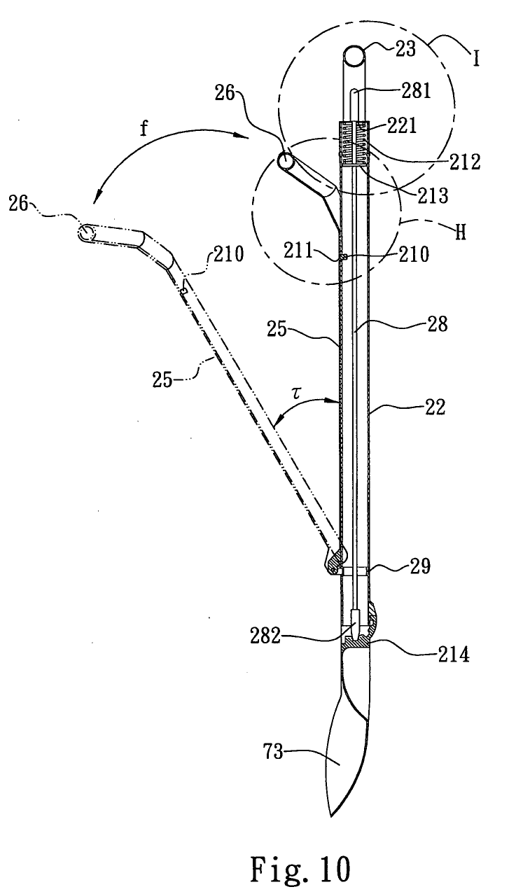

Referring to FIG. 8, a three-dimensional view of another preferred embodiment of the tool according to the present invention is shown. In the another preferred embodiment of the present invention, the tool of the present invention is a shovel 101 comprising: a main handle 22, with a first grip 23 provided on one end thereof; an auxiliary handle 25, with a second grip 26 provided on one end thereof, and pivotably connected to the main handle 22 at the other end thereof; a shovel bowl 7 (see in relation to FIG. 9 for a front view of the another preferred embodiment of the tool according to the present invention), having a connecting part 71, shoulders 72, and a shovel pan 73, the connecting part 71 of the shovel bowl 7 is fixedly locked on the other end of the main handle 22; and a pull rod 28 (see in relation to FIG. 10 for a cross-sectional view along the line B-B in FIG. 9), passing through the main handle 2, and a pull handle 281 and an engaging part 282 are respectively provided at either side thereof.

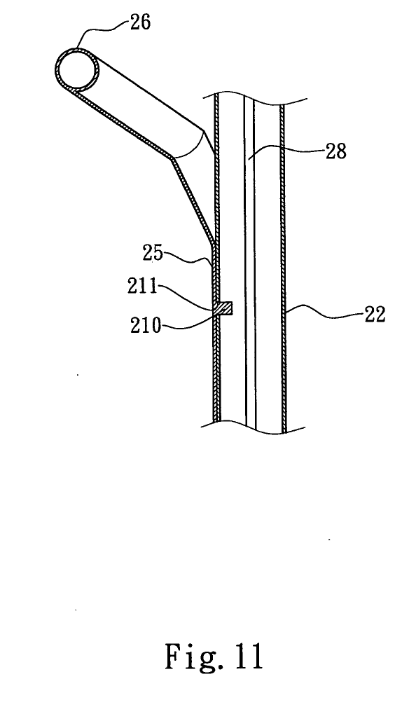

Continuing referring to FIG. 8, FIG. 9, and FIG. 10, the other end of the auxiliary handle 25 is provided with a fastening ring 29 for pivotably connecting the main handle 22, such that the auxiliary handle 25 can make a 360° rotational swing with respect to the main handle 22, and the auxiliary handle 25 is attached in the longitudinal direction of the main handle 22 via a protruding part 210 positioned into a hole 211 of the main handle 22 (referring to FIG. 11 for an enlarged view of the circle H shown in FIG. 10). When a user applies a force along the direction indicated by an arrow f in FIG. 10, an angle τ will be formed between the auxiliary handle 25 and the main handle 22.

When the first grip 23 and the second grip 26 are respectively held by two hands of a user, because the auxiliary handle 25 can be rotationally swung with respect to the main handle 22, the user can therefore adjust the angle τ spread between the auxiliary handle 25 and the main handle 22 and the direction as he wishes, such that the user can operate the shovel 101 under the condition most suitable for applying the force.

Continuing referring to FIG. 9, the shovel bowl 7 further pivotably provides treading parts 74. The treading parts 74 can be magnetically attached to the shoulders 72 and approximately vertical to the main handle 22. The treading parts 74 can also be movably adjusted (along the direction indicated by an arrow e shown in FIG. 9) and magnetically attached to the connecting part 71 and parallel to the main handle 22. When the shovel 101 is operated, a user can adjust the treading parts 74 to make them magnetically attached to the shoulders 72 and approximately vertical to the main handle 22. The treading parts 74 have the slip-proof function, such that a slip-off due to the moist weather or the user does not put on suitable shoes can be avoided when the user steps on the treading part 74 and applies a force downward.

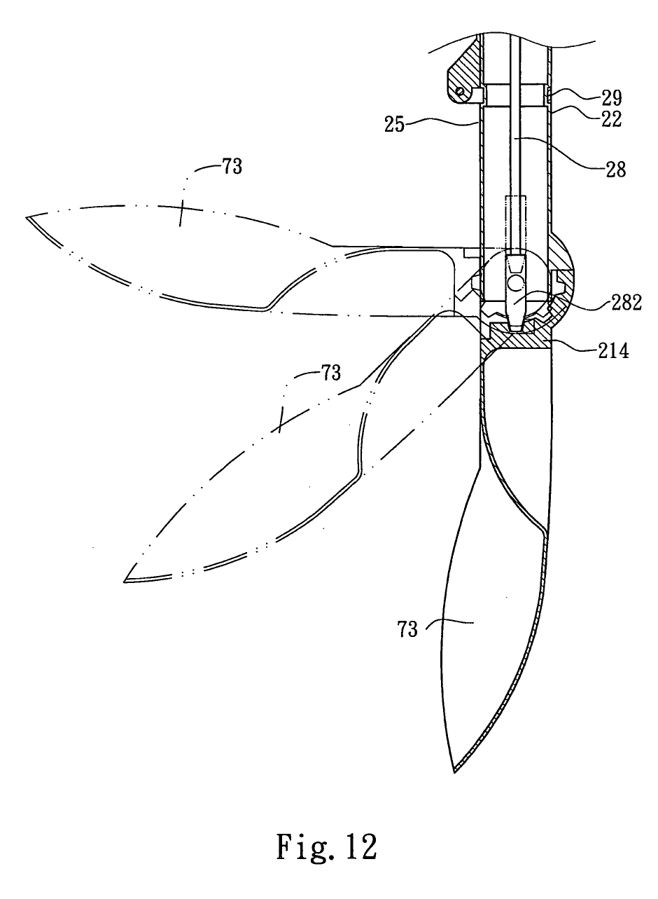

Referring to FIG. 10, a spring 212 passes through the pull rod 28. One end of the spring 212 stands up on the end 221 of the main handle 22, and the other end thereof stands up on a circle disk 213 provided on the pull rod 28. The shovel bowl 7 is further provided with a sprocket 214 for engaging with the engaging part 282 of the pull rod 28, such that different angles can exist between the shovel pan 73 of the shovel bowl 7 and the main handle 22 as shown in FIG. 12 for different angles between the shovel pan 73 and the main handle 22 for the convenience of a user to shovel various things.

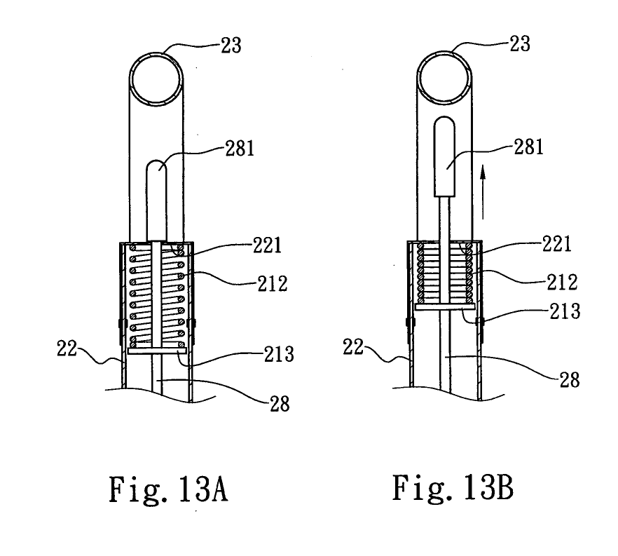

The user can operate the shovel 101 to insert the shovel pan 73 into the earth. When the user wants to shovel the earth, he can pull the pull handle 281 (referring to FIG. 13A and FIG. 13B for an enlarged view of the circle I shown in FIG. 10 and the stretching of the pull rod in utilizing conditions) and then the spring 212 will be pressed and the engaging part 282 will departs from the recess of the sprocket 214, such that the shovel pan 73 can be rotationally swung with respect to the main handle 22, that is the user can appropriately adjust or select the angle between the shovel pan 73 and the main handle 22. When the user releases the pull handle 281 (the spring 212 will resiliently return to the original location), the engaging part 282 will be positioned in the recess of the sprocket 214 in order to fix the shovel pan 73. Meanwhile, the user can shovel the earth by applying a force on the first grip 23 of the shovel 101 (using the second grip 26 as a fulcrum) or on the second grip 26 (using the first grip 23 as a fulcrum), and then the user can turn over the shovel pan 7 by rotating the arm holding the first grip 23, thereby the earth in the shovel pan 73 can be cleaned away. This is a convenient and effort-saving process.

After use, the user can position the auxiliary handle 25 into the hole 211 of the main handle 22 via the protruding part 210 of the auxiliary handle 25, such that the auxiliary handle 25 can be attached in the longitudinal direction of the main handle 22 for reducing the space occupied by the shovel 101 and for the convenience of store-up for the user.

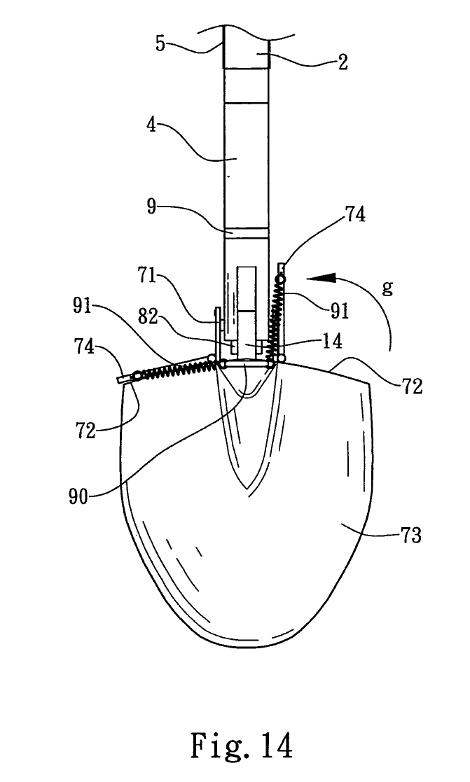

Referring to FIG. 14, a rear view of a preferred embodiment of the shovel bowl is shown. The shovel bowl 7 of the present invention further comprises a fastening part 90 and a spring 91. One end of the spring 91 is connected to the fastening part 90 and the other end thereof is connected to the treading part 74, such that the treading part 74 can be resiliently adjusted (along the direction indicated by an arrow g as shown). Optionally, the user can make the treading part 74 attached to the shoulder 72 and vertical to the main handle 2 or attached to the connecting part 71 and parallel to the main handle 2.

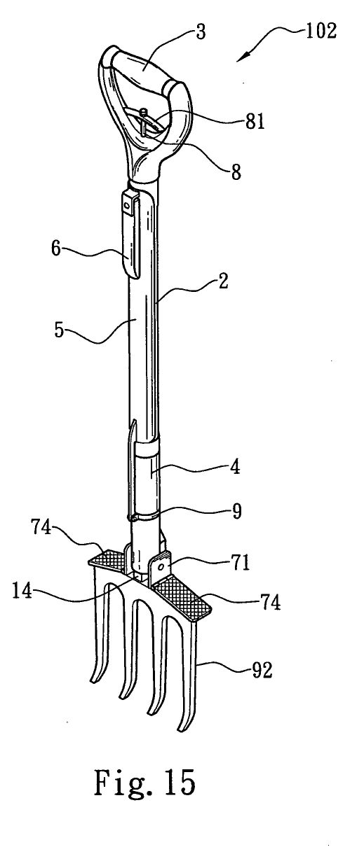

Referring to FIG. 15, a three-dimensional view of yet another preferred embodiment of the tool according to the present invention is shown. In the yet another preferred embodiment, the tool of the present invention is a fork 102. The fork 102 comprises a plurality of parallel-arranged legs 92 at the end for forking the crops or flowers, plants and trees. When a user pulls the pull handle 81, he can appropriately adjust or select the angle between the legs 92 and the main handle 2. The structure and function of the remaining elements in this example are the same as that of the shovel 101, and the description thereof is not duplicated.

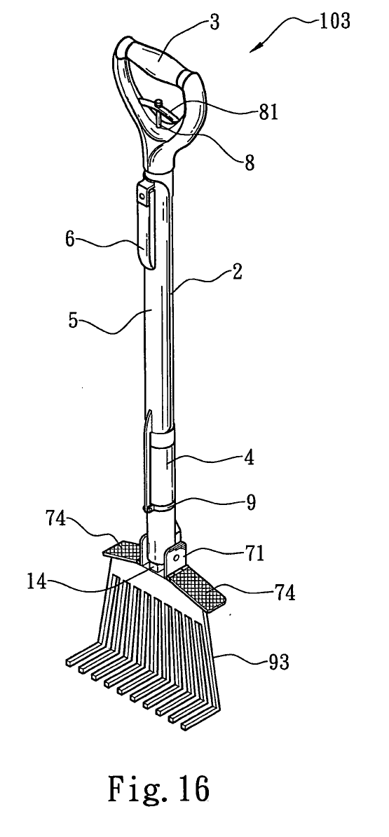

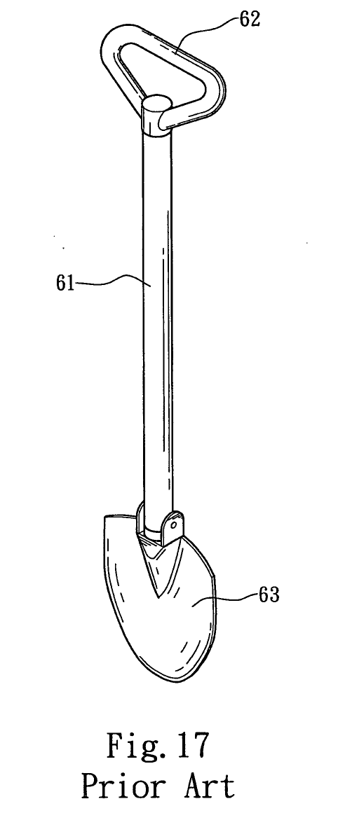

Referring to FIG. 16, a three-dimensional view of still yet another preferred embodiment of the tool according to the present invention is shown. In the still yet another preferred embodiment, the tool of the present invention is a rake 103. The rake 103 comprises a plurality of parallel-arranged claws 93 at the end for raking the crops, flowers, plants, trees, earth, and garbage. When a user pulls the pull handle 81, he can appropriately adjust or select the angle between the claws 93 and the main handle 2. The structure and function of the remaining elements in this example are the same as that of the shovel 101, and the description thereof is not duplicated.

Although the present invention has been described in considerable detail with reference to certain preferred embodiments thereof, these embodiments are not to be construed as limiting the invention. Those skilled in the art can easily make all kinds of alterations and changes within the spirit and scope of the present invention. Therefore, the protected scope of the present invention should not be limited to the description of the preferred embodiments contained herein, rather is defined only by the appended claims.

What is claimed is:

1. A tool, comprising:
a main handle;
a first grip, fixedly locked on one end of said main handle;
a connecting stick, fixedly locked on the other end of said main handle;
an auxiliary handle, one end thereof is pivotably provided on a second grip, and the other end thereof is pivotably connected to said connecting stick; and
a shovel bowl, having a connecting part, shoulders, and a shovel pan, said connecting part of said shovel bowl is fixedly locked on said connecting stick,
wherein said auxiliary handle is attached in the longitudinal direction of said main handle and can be rotationally swung with respect to said main handle.

2. The tool as claimed in claim 1, further comprising a pull rod passing through said main handle, and a pull handle and an engaging part are respectively provided at either side thereof.

3. The tool as claimed in claim 2, further comprising a spring passing through said pull rod, and one end thereof stands up on said first grip.

4. The tool as claimed in claim 2, wherein said shovel bowl is provided with a sprocket for engaging with said engaging part of said pull rod.

5. The tool as claimed in claim 1, wherein said shovel bowl is further pivotably provided with treading parts.

6. The tool as claimed in claim 5, wherein said shovel bowl further comprised a fastening part and a spring, one end of said spring is connected to said fastening part, and the other end of said spring is connected to said treading part.

7. The tool as claimed in claim 1, wherein the other end of said auxiliary handle is provided with a fastening ring for pivotably connecting said connecting stick.

8. The tool as claimed in claim 1, wherein said auxiliary handle is provided with a tenon, and a hole is provided at a place of said main handle corresponding to said tenon of said auxiliary handle, said tenon can be positioned into said hole of said main handle.

9. A tool, comprising:
a main handle, with a first grip provided on one end thereof;
an auxiliary handle 25, with a second grip provided on one end thereof, and pivotably connected to said main handle at the other end thereof; and
a shovel bowl, having a connecting part, shoulders, and a shovel pan, said connecting part of said shovel bowl is fixedly locked on the other end of said main handle,
wherein said auxiliary handle is attached in the longitudinal direction of said main handle and can be rotationally swung with respect to said main handle.

10. The tool as claimed in claim 9, further comprising a pull rod passing through said main handle, and a pull handle and an engaging part are respectively provided at either side thereof.

11. The tool as claimed in claim 10, further comprising a spring passing through said pull rod, and one end thereof stands up on the end of said main handle.

12. The tool as claimed in claim 10, wherein said shovel bowl is provided with a sprocket for engaging with said engaging part of said pull rod.

13. The tool as claimed in claim 9, wherein said shovel bowl is further pivotably provided with treading parts.

14. The tool as claimed in claim 13, wherein said shovel bowl further comprised a fastening part and a spring, one end of said spring is connected to said fastening part, and the other end of said spring is connected to said treading part.

15. The tool as claimed in claim 9, wherein the other end of said auxiliary handle is provided with a fastening ring for pivotably connecting said main handle.

16. The tool as claimed in claim 9, wherein said auxiliary handle is provided with a protruding part, and a hole is provided at a place of said main handle corresponding to said protruding part of said auxiliary handle, said protruding part can be positioned into said hole of said main handle.
